(19) United States
(12) Patent Application Publication
(10) Pub. No.: US 2017/0120277 A1
(43) Pub. Date: May 4, 2017

(54) TRIGGER-TYPE LIQUID DISPENSER

(71) Applicants: Kotaro FUJIWARA, Koto-ku, Tokyo (JP); Shigeo IIZUKA, Koto-ku, Tokyo (JP)

(72) Inventors: Kotaro FUJIWARA, Koto-ku, Tokyo (JP); Shigeo IIZUKA, Koto-ku, Tokyo (JP)

(73) Assignee: YOSHINO KOGYOSHO CO., LTD., Tokyo (JP)

(21) Appl. No.: 15/317,756

(22) PCT Filed: Jun. 29, 2015
(86) PCT No.: PCT/JP2015/003254

§ 371 Date: Dec. 9, 2016

(30) Foreign Application Priority Data
Jun. 30, 2014 (JP) 2014-135219
Dec. 26, 2014 (JP) 2014-265337

(51) Int. Cl. B05B 11/00

(52) U.S. Cl. CPC B05B 11/3067; B05B 11/3011; B05B 11/3077; B05B 11/3045; B05B 11/0059

(57) ABSTRACT

A trigger-type liquid dispenser, in which an upright and inverted dual unit includes a joint member, a pipe holding member, and a valve body. The joint member includes a through hole, which may be closed by the valve body, a valve-body-holding wall portion, which accommodates the valve body above the through hole in a manner such that the valve body is displaceable upward and downward, and an opening portion, which is formed in the valve-body-holding wall portion. In the inverted position, the upright and inverted dual unit permits content liquid contained in a container to be supplied to the dispenser main body by passing content liquid through a flow path from opening portion, through the hole, to the flow path defined between the joint member and pipe holding member sequentially. The valve body is inserted through the opening portion to be accommodated in the valve-body-holding wall portion.

### TECHNICAL FIELD

The present disclosure relates to a trigger-type liquid dispenser including a dispenser main body that is attached to a mouth of a container and that includes a pump, and an upright and inverted dual unit that allows supply of a content liquid to the dispenser main body regardless of whether the container is in an upright position or an inverted position. In detail, the present disclosure is to reduce the number of components in the upright and inverted dual unit and to facilitate assembly of the upright and inverted dual unit.

### BACKGROUND

Trigger-type liquid dispensers are widely used in containers containing a content liquid, such as an antimold, a detergent, a sizing agent for textiles, a household wax, a hair liquid, an aromatic, a repellent, a pesticide, and a medicine. Such a trigger-type liquid dispenser is mounted to a mouth of the container and injects the liquid contained in the container in the form of a straight jet, mist, or foam by actuation of a pump, disposed in a dispenser main body, in response to pulling of an operating lever, thereby allowing efficient supply of the content liquid. A known example of such a dispenser also includes an upright and inverted dual unit that allows supply of the content liquid to the dispenser main body regardless of whether the container is in the upright position or the inverted position.

For example, in the dispenser described in Patent Literature 1, the upright and inverted dual unit is configured by a joint member attached to the dispenser main body, a pipe holding member that is attached to the joint member and that holds a drawing pipe (which is configured by a tube member and an attachment member in Patent Literature 1) suspended in the container, an intermediate member interposed between the joint member and the pipe holding member to be held, and a valve body that may close from above a through hole provided in the intermediate member. Between the joint member and the intermediate member, there is defined a valve body receiving chamber in which the valve body is received above the through hole in a manner such that the valve body is displaceable upward and downward. Furthermore, the joint member is provided with an orifice through which the content liquid contained in the container is introduced into the valve receiving chamber.

In the inverted position of the container, the upright and inverted dual unit permits the content liquid contained in the container to be supplied to the dispenser main body by passing the content liquid through a flow path from the orifice, the valve body receiving chamber, the through hole, to a flow path defined between the intermediate member and the pipe holding member sequentially. On the other hand, in the upright position of the container, the upright and inverted dual unit permits the content liquid to be supplied from the drawing pipe to the dispenser main body by the valve body closing the through hole.

### CITATION LIST

### Patent Literature

### PTL 1: JP2005034714A

### SUMMARY

### Technical Problem

However, since the trigger-type liquid dispenser as described in Patent Literature 1 is configured by the four members, namely, the joint member, the pipe holding member, the intermediate member, and the valve body, and there is a demand for a further reduction in the number of components. Furthermore, in assembly of the upright and inverted dual unit from when the valve body is inserted between the joint member and the intermediate member to when the pipe holding member is attached to the joint member, the intermediate member might be disengaged from the joint member, and the valve body might fall. Accordingly, there is also a demand for facilitating the assembly.

The present disclosure has been conceived in view of the above current situation, and the present disclosure is to provide a trigger-type liquid dispenser that reduces the number of components in the upright and inverted dual unit and that facilitates assembly of the upright and inverted dual unit.

### Solution to Problem

Summary and features of the present disclosure are as follows.
1. A trigger-type liquid dispenser including a dispenser main body that is attached to a mouth of a container and that includes a pump, an upright and inverted dual unit that permits supply of a content liquid contained in the container to the dispenser main body regardless of whether the container is in an upright position or an inverted position, and an operation lever that is supported swingably by the dispenser main body and that is configured to actuate the pump, wherein the dispenser main body draws, pressurizes, and force-feeds the content liquid supplied from the upright and inverted dual unit and dispenses the content liquid through a nozzle attached to the dispenser main body due to actuation of the pump in response to pulling of the operation lever. The upright and inverted dual unit includes a joint member that is attached to the dispenser main body, a pipe holding member that is attached to the joint member and that holds a drawing pipe suspended in the container, and a valve body. The joint member includes a through hole that is closable from above by the valve body, a valve-body-holding wall portion that accommodates the valve body above the through hole in a manner such that the valve body is displaceable upward and downward and is prevented from slipping off, and an opening portion that is formed in the valve-body-holding wall portion. In the inverted position, the upright and inverted dual unit permits the content liquid contained in the container to be supplied to the dispenser main body by passing the content liquid through a flow path from the opening portion, the through hole, to a flow path defined between the joint member and the pipe holding member sequentially, and in the upright position, the upright and inverted dual unit permits the content liquid to be supplied from the drawing pipe to the dispenser main body by the valve body closing the through hole. The valve body is inserted through the opening portion to be accommodated in the valve-body-holding wall portion.
2. The trigger-type liquid dispenser according to 1, wherein the valve-body-holding wall portion includes a pair of curved plate portions facing to each other with a distance provided therebetween.
3. The trigger-type liquid dispenser according to 2, wherein the joint member further includes an inserted tubular portion that is inserted to the dispenser main body and that defines inside thereof a flow path for the content liquid, and the valve-body-holding wall portion is configured by a portion of an outer circumferential surface of the inserted tubular portion and the pair of curved plate portions.
4. The trigger-type liquid dispenser according to 2 or 3, wherein the valve-body-holding wall portion further includes a concave portion that, in a sideways position, permits the valve body to be positioned on an abutment surface of the valve-body-holding wall portion with respect to the valve body, with a predetermined gap provided with respect to the through hole.
5. The trigger-type liquid dispenser according to any one of 2 to 4, wherein each of the pair of curved plate portions includes a narrowed portion on un upper end edge of the curved plate portion, the narrowed portion being curved inward.
6. The trigger-type liquid dispenser according to 5, wherein the narrowed portion has a dome shape.
7. The trigger-type liquid dispenser according to any one of 1 to 6, wherein the joint member further includes, in a position thereof opposed to the pump about a center axis of a pipe holding tubular portion included in the pipe holding member, a plurality of ribs that is disposed in a circumferential direction at a predetermined interval and that extends in a direction of the center axis.

### Advantageous Effects

According to the present disclosure, the joint member includes the through hole that is closable from above by the valve body, the valve-body-holding wall portion that accommodates the valve body above the through hole in a manner such that the valve body is displaceable upward and downward and is prevented from slipping off, and the opening portion that is formed in the valve-body-holding wall portion. Furthermore, in the inverted position of the container, the upright and inverted dual unit permits the content liquid contained in the container to be supplied to the dispenser main body by passing the content liquid through a flow path from the opening portion, the through hole, to a flow path defined between the joint member and the pipe holding member sequentially, and in the upright position of the container, the upright and inverted dual unit permits the content liquid to be supplied from the drawing pipe to the dispenser main body by the valve body closing the through hole. Moreover, the valve body is inserted through the opening portion to be accommodated in the valve-body-holding wall portion. Accordingly, the upright and inverted dual unit may be configured by the three members, namely, the joint member, the pipe holding member, and the valve body. Thus, the intermediate member, which is conventionally needed, may be omitted, and the number of components is reduced. Besides, regarding assembly of the upright and inverted dual unit according to the present disclosure, the valve body is inserted through the opening portion to be accommodated in the valve-body-holding wall portion in a manner such that the valve body is prevented from slipping off. Accordingly, subsequent falling of the valve body is prevented, and the assembly is facilitated.

The present disclosure thus provides a trigger-type liquid dispenser that reduces the number of components in the upright and inverted dual unit and that facilitates the assembly of the upright and inverted dual unit.

### BRIEF DESCRIPTION OF THE DRAWINGS

In the accompanying drawings:

FIG. 1 is a side sectional view illustrating the state where a trigger-type liquid dispenser is attached to a mouth of a container according to the first embodiment of the present disclosure;

FIG. 2 is a partially enlarged view of FIG. 1, supplemented with a front view of a partition tube of a cylinder member;

FIG. 3A is a side sectional view, FIG. 3B is a front view, and FIG. 3C is a plan view, each illustrating a joint member constituting an upright and inverted dual unit of a trigger-type liquid dispenser illustrated in FIG. 1;

FIG. 4A is a side view, FIG. 4B is a side sectional view, FIG. 4C is a plan view, and FIG. 4D is a bottom view, each illustrating a pipe holding member constituting an upright and inverted dual unit of a trigger-type liquid dispenser illustrated in FIG. 1;

FIG. 5 is a side sectional view illustrating the state where a trigger-type liquid dispenser is attached to a mouth of a container according to the second embodiment of the present disclosure;

FIG. 6A is a side sectional view, FIG. 6B is a front view, FIG. 6C is a plan view, and FIG. 6D is a bottom view, each illustrating a joint member constituting an upright and inverted dual unit of a trigger-type liquid dispenser illustrated in FIG. 5; and

FIGS. 7A, 7B, and 7C are sectional views respectively illustrating an upright position, a sideways position, and an obliquely inverted position of a joint member and a pipe holding member that constitute a trigger-type liquid dispenser according to the second embodiment of the present disclosure.

### DETAILED DESCRIPTION

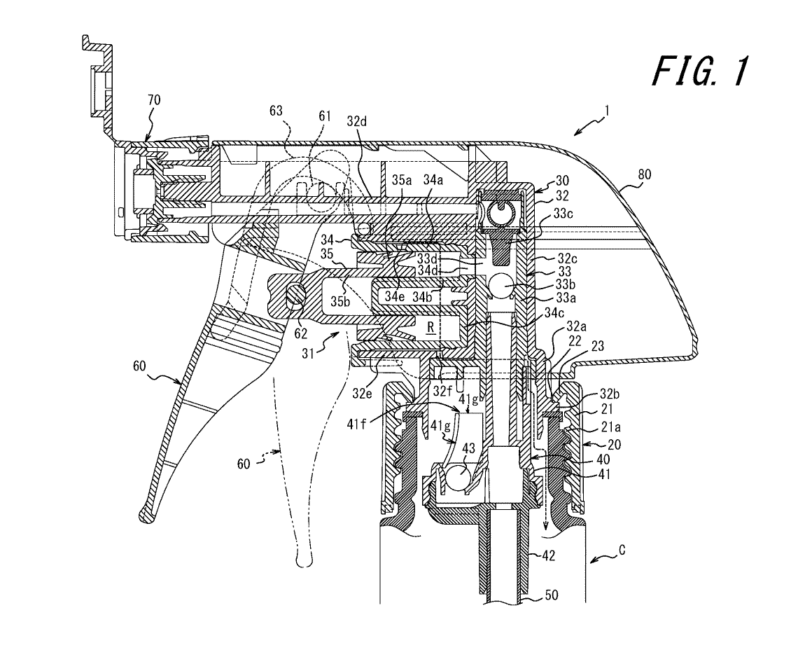

The present disclosure will be described in more detail below by illustration with reference to the drawings. Note that, in the specification, the claims, the abstract, and the drawings of the present disclosure, the side (corresponding to the upper side in FIG. 1) on which a top wall of a cover 80, which is later described, is located is defined as upper direction, and the side (corresponding to the lower side in FIG. 1) on which a fitting cap 20 is disposed is defined as lower direction. Furthermore, the side (corresponding to the left side in FIG. 1) on which a nozzle 70 is disposed is defined as front direction, and the opposing side (corresponding to the right side in FIG. 1) is defined as rear direction. Moreover, the directions (corresponding to the directions that are orthogonal to the drawing in FIG. 1) that are orthogonal to the upper-lower direction and the front-rear direction are defined as side directions.

As illustrated in FIG. 1, a trigger-type liquid dispenser 1 according to the first embodiment of the present disclosure includes the fitting cap 20, which is attached to a mouth of a container C, a dispenser main body 30, which holds the fitting cap 20 in a manner such that the fitting cap 20 is rotatable and is prevented from slipping off, an upright and inverted dual unit 40, which permits supply of a content liquid contained in the container C to the dispenser main body 30 regardless of whether the container C is in an upright position or an inverted position, a drawing pipe 50, which is suspended in the container C, an operation lever (trigger) 60, which is supported swingably by the dispenser main body 30 and configured to actuate a pump 31 included in the dispenser main body 30, the nozzle 70, which is attached to a front portion of the dispenser main body 30 to dispense the content liquid to the outside, and the cover 80, which covers the upper side and the sides of the dispenser main body 30.

The fitting cap 20 includes, on an inner surface of a cylindrical-shaped side wall 21 thereof, a screw portion 21a configured to engage with a screw portion provided in the mouth of the container C. Above the side wall 21, a ceiling wall 23, which is provided in the middle thereof with an upper orifice 22, is disposed.

In the present embodiment, the dispenser main body 30 is configured by a plurality of members, and the fitting cap 20 is attached to a body 32, which is one of the plurality of members. The body 32 includes a cylindrical-shaped coupling tubular portion 32a, which is inserted through the upper orifice 22 provided in the fitting cap 20, and also includes a flange 32b, which is disposed on an outer circumferential surface of the coupling tubular portion 32a to extend to the outer side in the radial direction. Below the flange 32b, a packing is also disposed to be sandwiched between an upper end of the mouth of the container C and the flange 32b. Furthermore, the body 32 includes, above the coupling tubular portion 32a, a longitudinal tube 32c, whose diameter is smaller than that of the coupling tubular portion 32a, and also includes, above the longitudinal tube 32c, a horizontal tube 32d, which extends toward the front side and which is connected to the longitudinal tube 32c. The nozzle 70 is disposed in a front end portion of the horizontal tube 32d. Below the horizontal tube 32d, a cylindrical-shaped fitting wall 32e, which protrudes toward the front side from the longitudinal tube 32c, is disposed.

There is also disposed a tubular portion 33a of an intake 33 inside the longitudinal tube 33c. Furthermore, the tubular portion 33a of the intake 33 is provided, inside thereof, with the first check valve 33b and the second check valve 33c that prevent backflow of the content liquid drawn by the pump 31. The first check valve 33b is brought into an opened state when the content liquid is drawn by the pump 31 and brought into a closed state when the drawn content liquid is pressurized and force-fed. On the other hand, the second check valve 33c is brought into a closed state when the content liquid is drawn by the pump 31 and brought into a closed state when the drawn content liquid is pressurized and force-fed toward the nozzle 70.

There is also provided a cylinder member 34 on the inner side of the fitting wall 32e of the body 32. The cylinder member 34 has a coaxial double-tube structure consisting of a cylindrical-shaped cylinder tube 34a, which is fitted to and held by the fitting wall 32e, and a cylindrical-shaped partition tube 34b, which is disposed on the inner side of the cylinder tube 34a in the radial direction. The cylinder tube 34a and the partition tube 34b are connected to each other on the rear sides thereof via a back wall 34c.

The back wall 34c is provided with a hole 34d that is fitted in a hole of the longitudinal tube 32c and that communicates with a hole 33d of the intake 33. Furthermore, the cylinder tube 34a is provided, on the side thereof, with an ambient air inlet 34e that permits the inside of the cylinder tube 34a to communicate with the outside and that communicates with a hole 32f provided in the fitting wall 32e via a gap formed between the fitting wall 32e and the cylinder tube 34a.

Inside the cylinder member 34, a piston 35 is disposed. The piston 35 seals the inside of the cylinder member 34 and defines a cylinder chamber R. The piston 35 includes an annular-shaped slide portion 35a, which slidably abuts against an inner circumferential surface of the cylinder tube 34a, and the slide portion 35a is provided with a circumferential wall portion 35b, which extends toward the front side and which has a closed front end. Additionally, the slide portion 35a closes the aforementioned ambient air inlet 34e provided in the cylinder member 34 in the state where the operating lever 60 is not pulled.

To the dispenser main body 30, the operation lever 60, which is rotatable about a pivot shaft 61, is fitted. The operation lever 60 is coupled to a front end of the piston 35 by a pin member 62 in a manner such that the operation lever 60 is rotatable. Furthermore, the operation lever 60 is urged toward a direction (a clockwise direction centered about the pivot shaft 61 in FIG. 1) away from the pump 31 by a curve-shaped plate spring 63, which has one end fixed to and held by the dispenser main body 30 and also has a front end locked to the operation lever 60.

Although in the present embodiment the pump 31 is configured by the cylinder member 34 and the piston 35, the present disclosure is not limited to this configuration, and it is possible to adopt a variety of configurations and structures, which permits the content liquid supplied from the upright and inverted dual unit 40 to be drawn, pressurized, and force-fed to be dispensed through the nozzle 70 due to actuation of the pump 31 in response to pulling of the operation lever 60.

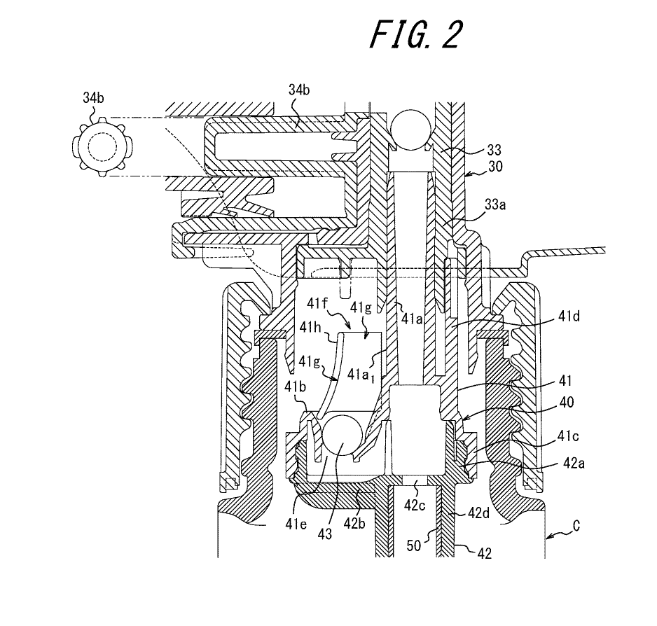

As illustrated in FIG. 2, the upright and inverted dual unit 40 is attached between the drawing pipe 50 and the intake 33. The upright and inverted dual unit 40 includes a joint member 41, which is attached to the dispenser main body 30, a pipe holding member 42, which is attached to the joint member 41 to hold the drawing pipe 50 suspended in the container C, and a spherical-shaped valve body 43.

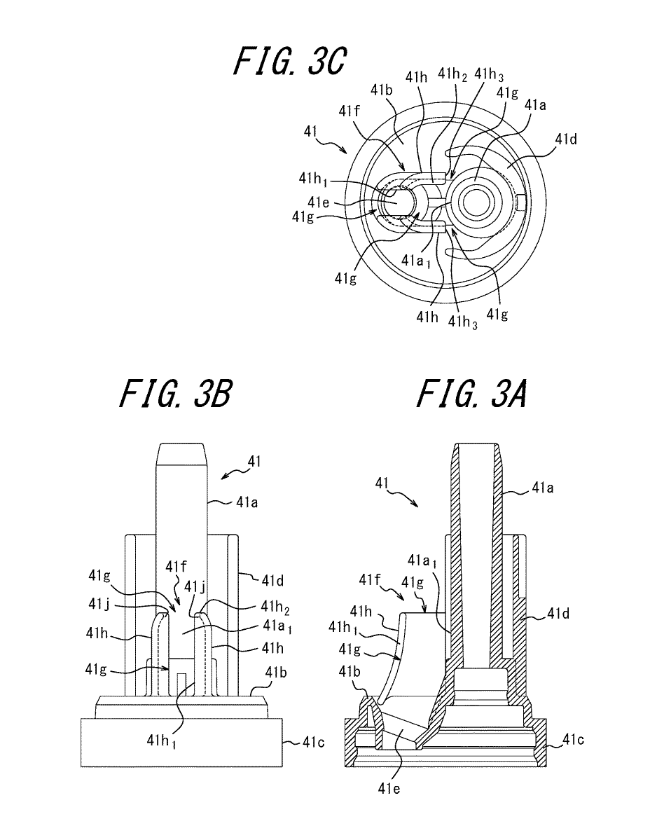

As illustrated in FIG. 2 and FIGS. 3A to 3C, the joint member 41 includes an inserted tubular portion 41a, which is inserted to the tubular portion 33a of the intake 33 of the dispenser main body 30 and which defines inside thereof a flow path for the content liquid, a ceiling wall portion 41b, which extends to the outer side in the radial direction from a lower end of the inserted tubular portion 41a, an attachment wall portion 41c, which suspends from an outer circumferential edge of the ceiling wall portion 41b, and an auxiliary tubular portion 41d, which stands from the ceiling wall portion 41b on the outer side of the inserted tubular portion 41a in the radial direction. The ceiling wall portion 41b is provided with a through hole 41e, which may be closed from above by the valve body 43.

The joint member 41 further includes a valve-body-holding wall portion 41f, which accommodates the valve body 43 above the through hole 41e in a manner such that the valve body 43 is displaceable upward and downward and is prevented from slipping off, and an opening portion 41g, which is formed in the valve-body-holding wall portion 41f. The valve-body-holding wall portion 41f is configured by a portion 41a₁ of an outer circumferential surface of the inserted tubular portion 41a and a pair of curved plate portions 41h, which stand from the ceiling wall portion 41b and oppose to each other at a distance therebetween.

In the present embodiment, the opening portion 41g is formed between front end edges 41h₁ of the pair of curved plate portions 41h, between upper end edges 41h₂ of the pair of curved plate portions 41h, and between each of rear end edges 41h₃ of the pair of curved plate portions 41h and the inserted tubular portion 41a. The upper end edges 41h₂ of the pair of curved plate portion 41h are formed as narrowed portions 41j, which are curved to narrow the distance between the pair of curved plate portions 41h as the curved plate portions 41h extend upward. The valve body 43 may be inserted through the opening portion 41g between the upper end edges 41h₂ of the pair of curved plate portions 41h by pressing the valve body 43 from above against the narrowed portions 41j. Thus, the valve body 43 may be accommodated in the valve-body-holding wall portion 41f. Herein, for smooth displacement of the valve body 43 due to its own weight, the valve body 43 is preferably made of metal, and the joint member 41 is preferably made of synthetic resin. This preferably allows insertion of the valve body 43 due to elastic deformation of the upper end edges 41h₂ of the pair of curved plate portion 41h.

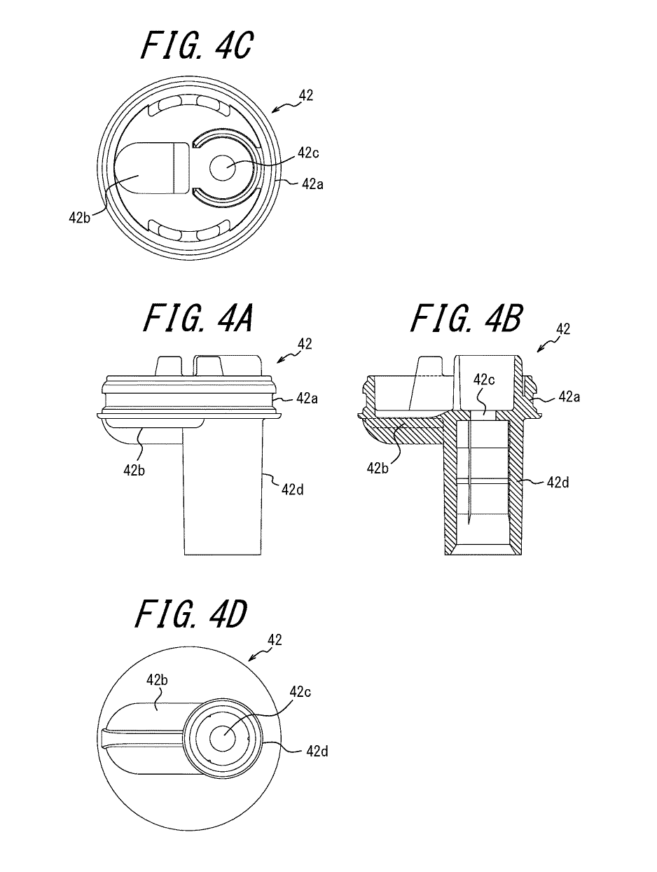

As illustrated in FIG. 2, FIGS. 3A to 3C, and FIGS. 4A to 4D, the pipe holding member 42 includes an outer circumferential wall portion 42a, which is fitted in the attachment wall portion 41c of the joint member 41, a bottom wall portion 42b, which extends to the inner side in the radial direction from a lower and of the outer circumferential wall portion 42a and which defines a flow path between the bottom wall portion 42b and the ceiling wall portion 41b of the joint member 41, a hole portion 42c, which is formed in the bottom wall portion 42b, and a pipe holding tubular portion 42d, which is suspended from the bottom wall portion 42b on the outer side in the radial direction of the hole portion 42d to hold the drawing pipe 50.

In the inverted position of the container C, the upright and inverted dual unit 40 permits the content liquid contained in a container C to be supplied to the dispenser main body 30 by passing the content liquid through a flow path from the opening portion 41g, the through hole 41e, to a flow path defined between the ceiling wall portion 41b of the joint member 41 and the bottom wall portion 42b of the pipe holding member 42 sequentially. On the other hand, in the upright position of the container C, the upright and inverted dual unit 40 permits the content liquid to be supplied from the drawing pipe 50 to the dispenser main body 30 by the valve body 43 closing the through hole 41e.

Next, a description is given of a sequence of operation from actuation of the pump 31 to delivery of the liquid contained in the container C to the nozzle 70 in the upright position, as an example.

Once the operation lever 60 is operated manually and pulled to a stroke limit position represented by a two-dot chain line in FIG. 1 toward the pump 31, the first check valve 33b is closed, and the piston 35 is pushed into the partition chamber 34b. This increases liquid pressure in the pump 31 and causes the liquid within the pump 31 to be delivered from the hole 34d to the nozzle 70 via the second check valve 33c.

When the operation of the operation lever 60 is released, the operation lever 60 is returned to an initial position due to resilience of the plate spring 63. In conjunction with the return movement, the second check valve 33c is closed, the first check valve 33b is opened, and the liquid contained in the container C is drawn from the hole 34d into the pump 31 via the drawing pipe 50 and the first check valve 33b. Additionally, the aforementioned ambient air inlet 34e is provided in a position of the cylinder tube 34a that permits the ambient air inlet 34e to be exposed to the outside when the operation lever 60 is operated to the stroke limit. The ambient air inlet 34e permits the inside of the cylinder tube 34a to communicate with the outside and also communicates with the hole 32f provided in the fitting wall 32e via the gap formed between the fitting wall 32e and the cylinder tube 34a. As represented by a dash line arrow in FIG. 1, air drawn through the ambient air inlet 34e passes through the gap between the cylinder tube 34a of the pump 31 and the fitting wall 32e and subsequently, passes through the hole 32f. After passing through the hole 32f, air passes through a gap formed between the fitting wall 32e and the tubular portion 33a and then, passes through a gap formed between the auxiliary tubular portion 41d of the joint member 41 and the mouth of the container C, and thus, air is drawn into the container C. Accordingly, after the content liquid is dispensed, the space in the container C is replaced with air.

By thus fitting the trigger-type liquid dispenser 1 according to the present disclosure to the mouth of the container C and repeating the pulling and the releasing operation of the operation lever 60, the pump 31 is actuated to deliver the liquid contained in the container C to the nozzle 70 through the first check valve 33b and the second check valve 33c.

According to the trigger-type liquid dispenser 1 of the present embodiment with the above configuration, the joint member 41 includes the through hole 41e, which may be closed from above by the valve body 43, a valve-body-holding wall portion 41f, which accommodates the valve body 43 above the through hole 41e in a manner such that the valve body 43 is displaceable upward and downward and is prevented from slipping off, and an opening portion 41g, which is formed in the valve-body-holding wall portion 41f. Furthermore, in the inverted position of the container C, the upright and inverted dual unit 40 permits the content liquid contained in the container C to be supplied to the dispenser main body 30 by passing the content liquid through a flow path from the opening portion 41g, the through hole 41e, to a flow path defined between the joint member 41 and the pipe holding member 42 sequentially, and in the upright position of the container C, the upright and inverted dual unit 40 permits the content liquid to be supplied from the drawing pipe 50 to the dispenser main body 30 by the valve body 43 closing the through hole 41e. Moreover, the valve body 43 is inserted through the opening portion 41g to be accommodated in the valve-body-holding wall portion 41f. Accordingly, the upright and inverted dual unit 40 may be configured by the three members, namely, the joint member 42, the pipe holding member 42, and the valve body 43. Thus, the intermediate member, which is conventionally needed, may be omitted, and the number of components is reduced.

Besides, regarding assembly of the upright and inverted dual unit 40 according to the trigger-type liquid dispenser 1, the valve body 43 is inserted through the opening portion 41g to be accommodated in the valve-body-holding wall portion 41f in a manner such that the valve body 43 is prevented from slipping off. Accordingly, subsequent falling of the valve body 43 is prevented, and the assembly is facilitated.

The descriptions above are considered to be merely illustrative of one of embodiments of the present disclosure, and various changes may be made within the scope of the claims. For example, in the description of the above embodiment, the upper end edges 41h₂ of the pair of curved plate portion 41h are formed as narrowed portions 41j, and the valve body 43 is inserted through the opening portion 41g formed between the upper end edges 41h₂ of the pair of curved plate portions 41h to be accommodated in the valve-body-holding wall portion 41f. However, the present disclosure is not limited to the above configuration, and for example, the narrowed portions 41j, through which the valve body 43 may be inserted, may be formed in the front end edges 41h₁ of the pair of curved plate portions 41h, and the valve body 43 may be inserted through the opening portion 41g formed between the front end edges 41h₁ of the pair of curved plate portions 41h to be accommodated in the valve-body-holding wall portion 41f.

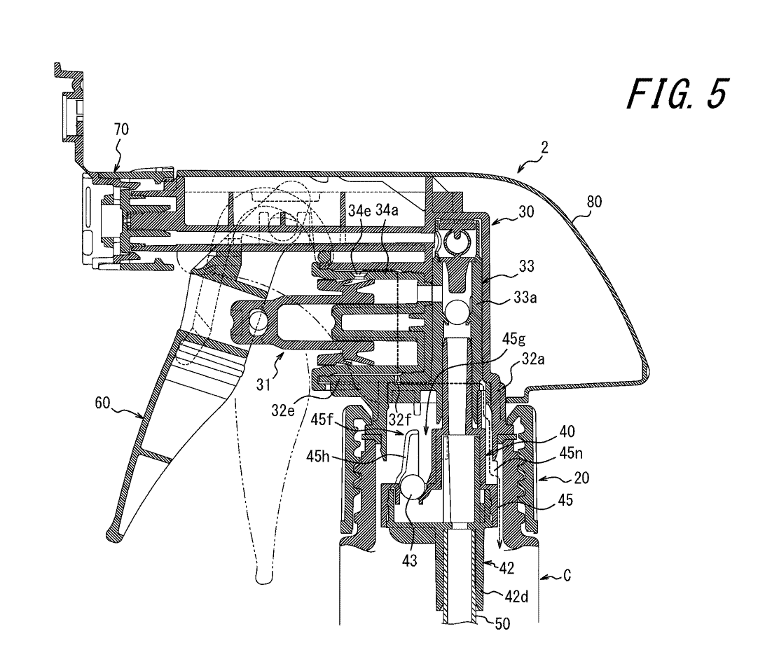

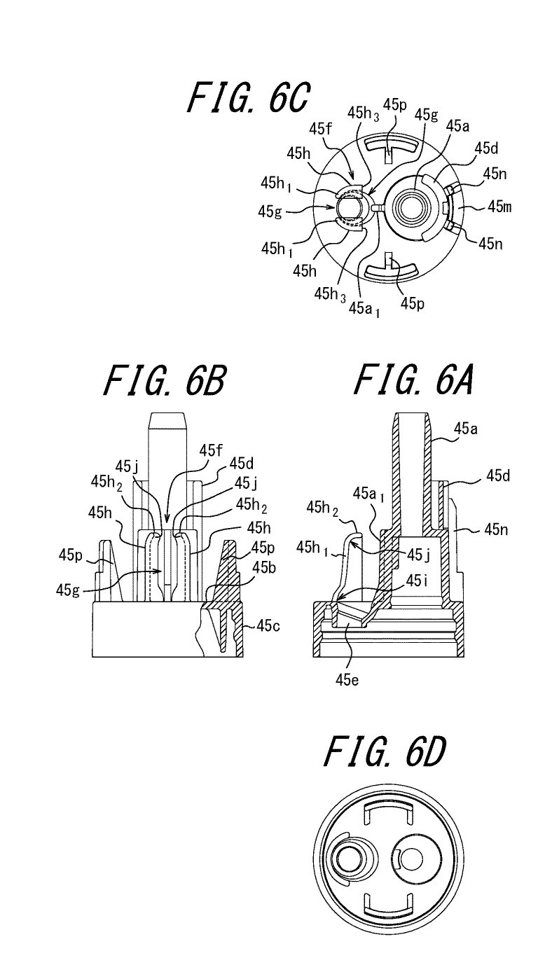

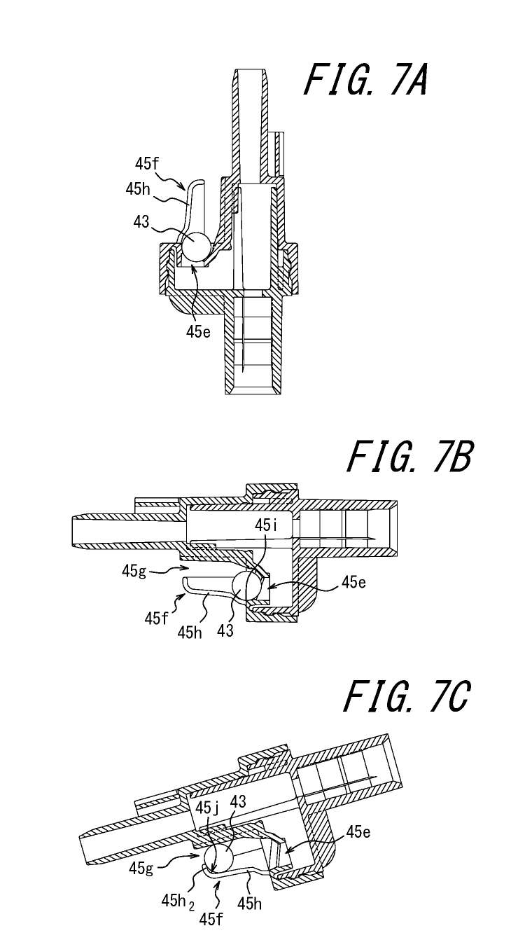

Next, a description is given of a trigger-type liquid dispenser 2 according to the second embodiment of the present disclosure with reference to FIG. 5, FIGS. 6A to 6D, and FIGS. 7A to 7C.

As illustrated in FIG. 5, the trigger-type liquid dispenser 2 according to the second embodiment of the present disclosure includes the fitting cap 20, which is attached to a mouth of the container C, the dispenser main body 30, which holds the fitting cap 20 in a manner such that the fitting cap 20 is rotatable and is prevented from slipping off, the upright and inverted dual unit 40, which permits supply of a content liquid contained in the container C to the dispenser main body 30 regardless of whether the container C is in an upright position or an inverted position, the drawing pipe 50, which is suspended in the container C, the operation lever (trigger) 60, which is supported swingably by the dispenser main body 30 and configured to actuate the pump 31 included in the dispenser main body 30, the nozzle 70, which is attached to a front portion of the dispenser main body 30 to dispense the content liquid to the outside, and the cover 80, which covers the upper side and the sides of the dispenser main body 30.

The trigger-type liquid dispenser 2 according to the second embodiment of the present disclosure illustrated in FIG. 5 differs from the trigger-type dispenser 1 according to the first embodiment of the present disclosure illustrated in FIG. 1 only in that the shape and the function of the joint member 45 of the upright and inverted dual unit 40 partly differ from those of the joint member 41. Accordingly, the description below focuses on differences from the trigger-type dispenser 1 according to the first embodiment of the present disclosure.

As illustrated in FIG. 5, the upright and inverted dual unit 40 is attached between the drawing pipe 50 and the intake 33. The upright and inverted dual unit 40 includes the joint member 45, which is attached to the dispenser main body 30, the pipe holding member 42, which is attached to the joint member 45 to hold the drawing pipe 50 suspended in the container C, and the spherical-shaped valve body 43.

As illustrated in FIG. 5 and FIGS. 6A to 6D, the joint member 45 includes an inserted tubular portion 45a, which is inserted to the tubular portion 33a of the intake 33 of the dispenser main body 30 and which defines inside thereof a flow path for the content liquid, a ceiling wall portion 45b, which extends to the outer side in the radial direction from a lower end of the inserted tubular portion 45a, an attachment wall portion 45c, which is suspended from an outer circumferential edge of the ceiling wall portion 45b, and an auxiliary tubular portion 45d, which stands from the ceiling wall portion 45b on the outer side in the radial direction of the inserted tubular portion 45a. The ceiling wall portion 45b is provided with a through hole 45e, which may be closed from above by the valve body 43.

The joint member 45 further includes a valve-body-holding wall portion 45f, which accommodates the valve body 43 above the through hole 45e in a manner such that the valve body 43 is displaceable upward and downward and is prevented from slipping off, and an opening portion 45g, which is formed in the valve-body-holding wall portion 45f. The valve-body-holding wall portion 45f is configured by a protruding portion 45a₁, which protrudes from an outer circumferential surface of the inserted tubular portion 45a further toward the valve body 43, and a pair of curved plate portions 45h, which stand from the ceiling wall portion 45b vertically and oppose to each other at a distance therebetween.

In the present embodiment, the opening portion 45g is formed between front end edges 45h₁ of the pair of curved plate portions 45h, between upper end edges 45h₂ of the pair of curved plate portions 45h, and between each of rear end edges 45h₃ of the pair of curved plate portions 45h and the protruding portion 45a₁ protruding from the inserted tubular portion 45a. As illustrated in FIG. 6B, the upper end edges 45h₂ of the pair of curved plate portion 45h are formed as narrowed portions 45j, which are curved to narrow the distance between the pair of curved plate portions 45h as the curved plate portions 45h extend upward. Furthermore, as illustrated in FIG. 6A, the upper end edges 45h₂ each have a dome shape, and the narrowed portions 45j are curved inward. The valve body 43 may be inserted through the opening portion 45g between the upper end edges 45h₂ of the pair of curved plate portions 45h by pressing the valve body 43 from above against the narrowed portions 45j. Thus, the valve body 43 may be accommodated in the valve-body-holding wall portion 45f. Herein, for smooth displacement of the valve body 43 due to its own weight, the valve body 43 is preferably made of metal, and the joint member 45 is preferably made of synthetic resin. This preferably allows insertion of the valve body 43 due to elastic deformation of the upper end edges 45h₂ of the pair of curved plate portion 45h.

In FIGS. 6B and 6C, a support member 45p is illustrated. The support member 45p is used to position and support the joint member 45 with respect to the intake 33 and the body 32.

Additionally, although in the present embodiment the upper end edges 45h₂ each have a dome shape, the present disclosure is not limited to this embodiment, and the upper end edges 45h₂ only need to include the narrowed portions 45j, which are curved to be narrowed inward.

In the upright position of the container C, as illustrated in FIG. 7A, the upright and inverted dual unit 40 permits the content liquid to be supplied to the dispenser main body 30 from the drawing pipe 50 to the dispenser main body 30 by the valve body 43 closing the through hole 45e.

Then, when the container C is brought to a sideways position, the valve body 43 is displaced in a direction away from the through hole 45e, thereby opening the through hole 45e. At this time, in cases where the through hole 45e is not completely filled with the content liquid, air from the ambient air inlet 34e, together with the content liquid, is drawn into the cylinder tube 34a through the through hole 45e. Consequently, the air-entrained content liquid is dispensed.

In the present embodiment, the valve body 43 is received in the concave portion 45i and positioned in the vicinity of the through hole 45e with a predetermined gap maintained with respect to the through hole 45e. Accordingly, when the operation lever 60 is returned to an initial position due to resilience of the plate spring 63 and when the through hole 45e is placed under negative pressure, the valve body 43 is quickly displaced to closely contact the through hole 45e for sealing. This prevents inflow of air from the ambient air inlet 34e through the through hole 45e. Additionally, in the sideways position, the content liquid is supplied mainly from the drawing pipe 50.

Then, as illustrated in FIG. 7C, when the container C is tilted so that the mouth of the container C faces obliquely downward, the content liquid is supplied to the surroundings of the valve-body-holding wall portion 45f in a reliable manner. The valve body 43 is displaced toward the upper end edges 45h₂, and the content liquid is supplied to the dispenser main body 30 thorough the through hole 45e. The upper end edges 45h₂, which include the dome-shaped narrowed portions 45j, of the curved plate portions 45h hinder movement of the valve body 43, thus requiring the valve body 43 to stay within the valve-body-holding wall portion 45f. Accordingly, operation of the trigger-type liquid dispenser 2 in the above state where the mouth of the container C faces obliquely downward is similar to operation in the inverted position.

Additionally, the joint member 45 in the present embodiment includes, in a position thereof opposed to the pump 31 about the center axis of the pipe holding tubular portion 42d included in the pipe holding member 42, two ribs 45n, which are disposed at a predetermined interval in the circumferential direction and which extend longitudinally. When the operation lever 60 is returned to the original position due to resilience of the plate spring 63 and when the inside of the cylinder tube 34a is placed under negative pressure, the content liquid contained in the container C is filled into the cylinder tube 34a, thereby placing the inside of the container C under negative pressure. At this time, as represented by a dash line arrow in FIG. 5, air drawn through the ambient air inlet 34e passes through the gap between the cylinder tube 34a of the pump 31 and the fitting wall 32e and subsequently, passes through the hole 32f. After passing through the hole 32f, air passes through the gap formed between the fitting wall 32e and the tubular portion 33a and reaches the ribs 45n. Air proceeds downward along an interval 45m formed between the ribs 45n and flows into the container C. In this way, air, introduced from the ambient air inlet 34e, reaches the container C by passing through a bypass passage, which is more restricted compared with the first embodiment. Accordingly, inflow of the air is restricted by greater inflow resistance, and it is ensured that air, introduced from the ambient air inlet 34e, may be prevented from passing through the through hole 45e directly to reach the pump 31.

According to the trigger-type liquid dispenser 2 of the present embodiment, the valve-body-holding wall portion 45f includes the concave portion 45i. In the sideways position, the concave portion 45i permits the valve body 43 to be positioned on an abutment surface of the valve-body-holding wall portion 45f with respect to the valve body 43, with a predetermined gap provided with respect to the through hole 45e. Accordingly, when the through hole 45e is placed under negative pressure in the sideways position, the valve body 43 quickly seals the through hole 45e, and this prevents inflow of air from the ambient air inlet 34e through the through hole 45e.

Moreover, according to the trigger-type liquid dispenser 2, the pair of curved plate portions 45h include, in the upper end edges 45h₂ thereof, the dome-shaped narrowed portions 45j, which are curved inward. Accordingly, it is ensured that the valve body 43 may be prevented from falling off the valve-body-holding wall portion 45f.

Moreover, according to the trigger-type liquid dispenser 2, the joint member 45 includes, in a position thereof opposed to the pump 31 about the center axis of the pipe holding tubular portion 42d included in the pipe holding member 42, the plurality of ribs 45n, which is disposed at a predetermined interval in the circumferential direction and which extends in the direction of the center axis. Accordingly, air, introduced from the ambient air inlet 34e, passes through the bypass passage to reach the container C, and inflow of air is restrained by a predetermined inflow resistance. It is therefore ensured that air, introduced from the ambient air inlet 34e, may be prevented from passing through the through hole 45e directly to reach the pump 31.

### REFERENCE SIGNS LIST

1 Trigger-type liquid dispenser
20 Fitting cap
21 Side wall
21a Screw portion
22 Upper orifice
23 Ceiling wall
30 Dispenser main body
31 Pump
32 Body
32a Coupling tubular portion
32b Flange
32c Longitudinal tube
32d Horizontal tube
32e Fitting wall
32f Hole
33 Intake
33a Tubular portion
33b First check valve
33c Second check valve
33d Hole
34 Cylinder member
34a Cylinder tube
34b Partition tube
34c Back wall
34d Hole
34e Ambient air inlet
35 Piston
35a Slide portion
35b Circumferential wall portion
40 Upright and inverted dual mechanism
41, 45 Joint member
41a, 45a Inserted tubular portion
41a₁ Portion of outer circumferential surface of inserted tubular portion
41b, 45b Ceiling wall portion
41c, 45c Attached wall portion
41d, 45d Auxiliary tubular portion
41e, 45e Through hole
41f, 45f Valve-body-holding wall portion
41g, 45g Opening portion
41h, 45h Pair of curved plate portions
41h₁, 45h₁ Front end edges of pair of curved plate portions
41h₂, 45h₂ Upper end edges of pair of curved plate portions
41h₃, 45h₃ Rear end edges of pair of curved plate portions
41j, 45j Narrowed portion
42 Pipe holding member
42a Outer circumferential portion
42b Bottom wall portion
42c Hole portion
42d Pipe holding tubular portion
43 Valve body
45a₁ Protruding portion
45i Concave portion
45m Interval
45n Rib
45p Support member
50 Drawing pipe
60 Operating lever
61 Pivot shaft
62 Pin member
63 Plate spring
70 Nozzle
80 Cover
C Container
R Cylinder chamber

1. A trigger-type liquid dispenser comprising a dispenser main body that is attached to a mouth of a container and that includes a pump, an upright and inverted dual unit that permits supply of a content liquid contained in the container to the dispenser main body regardless of whether the container is in an upright position or an inverted position, and an operation lever that is supported swingably by the dispenser main body and that is configured to actuate the pump, wherein the dispenser main body draws, pressurizes, and force-feeds the content liquid supplied from the upright and inverted dual unit and dispenses the content liquid through a nozzle attached to the dispenser main body due to actuation of the pump in response to pulling of the operation lever, and wherein
the upright and inverted dual unit includes a joint member that is attached to the dispenser main body, a pipe holding member that is attached to the joint member and that holds a drawing pipe suspended in the container, and a valve body,
the joint member includes a through hole that is closable from above by the valve body, a valve-body-holding wall portion that accommodates the valve body above the through hole in a manner such that the valve body is displaceable upward and downward and is prevented from slipping off, and an opening portion that is formed in the valve-body-holding wall portion,
in the inverted position, the upright and inverted dual unit permits the content liquid contained in the container to be supplied to the dispenser main body by passing the content liquid through a flow path from the opening portion, the through hole, to a flow path defined between the joint member and the pipe holding member sequentially, and in the upright position, the upright and inverted dual unit permits the content liquid to be supplied from the drawing pipe to the dispenser main body by the valve body closing the through hole, and
the valve body is inserted through the opening portion to be accommodated in the valve-body-holding wall portion.

2. The trigger-type liquid dispenser according to claim 1, wherein the valve-body-holding wall portion includes a pair of curved plate portions facing to each other with a distance provided therebetween.

3. The trigger-type liquid dispenser according to claim 2, wherein
the joint member further includes an inserted tubular portion that is inserted to the dispenser main body and that defines inside thereof a flow path for the content liquid, and
the valve-body-holding wall portion is configured by a portion of an outer circumferential surface of the inserted tubular portion and the pair of curved plate portions.

4. The trigger-type liquid dispenser according to claim 2, wherein the valve-body-holding wall portion further includes a concave portion that, in a sideways position, permits the valve body to be positioned on an abutment surface of the valve-body-holding wall portion with respect to the valve body, with a predetermined gap provided with respect to the through hole.

5. The trigger-type liquid dispenser according to claim 2, wherein each of the pair of curved plate portions includes a narrowed portion on un upper end edge of the curved plate portion, the narrowed portion being curved inward.

6. The trigger-type liquid dispenser according to claim 5, wherein the narrowed portion has a dome shape.

7. The trigger-type liquid dispenser according to claim 1, wherein the joint member further includes, in a position thereof opposed to the pump about a center axis of a pipe holding tubular portion included in the pipe holding member, a plurality of ribs that is disposed in a circumferential direction at a predetermined interval and that extends in a direction of the center axis.
